(19) United States
(12) Patent Application Publication
(10) Pub. No.: US 2026/0357002 A1
(43) Pub. Date: Nov. 12, 2026

(54) AQUEOUS RADIATION CURABLE COMPOSITION

(71) Applicant: ALLNEX BELGIUM, S.A., Drogenbos (BE)

(72) Inventors: Elodie SIBAND, Uccle (BE); Lieven DEPUYDT, Grimbergen (BE)

(73) Assignee: ALLNEX BELGIUM, S.A., Drogenbos (BE)

(21) Appl. No.: 19/126,480

(22) PCT Filed: Oct. 23, 2023
(86) PCT No.: PCT/EP2023/079471

§ 371 Date: May 1, 2025

(30) Foreign Application Priority Data
Nov. 10, 2022 (EP) 22206650.8

(51) Int. Cl. C08F 290/06; C08F 2/50; C08G 18/08; C08G 18/22; C08G 18/24; C08G 18/34; C08G 18/44; C08G 18/66; C08G 18/67; C09D 5/02; C09D 7/61; C09D 175/16

(52) U.S. Cl. CPC C08F 290/067; C08F 2/50; C08G 18/0823; C08G 18/227; C08G 18/246; C08G 18/348; C08G 18/44; C08G 18/6659; C08G 18/673; C09D 5/024; C09D 7/61; C09D 175/16; C08G 2150/00

(57) ABSTRACT

An aqueous radiation curable composition comprising: a) from 45 to 80 wt. % of at least one (polymerizable) (water-insoluble) ethylenically unsaturated compound (A); and b) from 20 to 55 wt. % of at least one (polymerizable) ethylenically unsaturated polyurethane polymer (B) obtained from the reaction of: i. at least one polyisocyanate compound (i); ii. at least one polymeric polyol (ii); iii. at least one (non-polymerizable) hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt; iv. at least one compound (iv) comprising at least one (essentially one) reactive group capable of reacting with isocyanate groups and further comprising at least one ethylenically unsaturated group; and v. optionally, at least one (non-polymerizable) compound (v) comprising at least one (essentially one) reactive group capable of reacting with isocyanate groups; and wherein compounds (A), (i), (ii), (iii), (iv) and (v) are all different from each other, and wherein the wt. % are based on the total dry content weight of the radiation curable composition.

### TECHNICAL FIELD

The present invention relates to an aqueous radiation curable composition and to a coating composition comprising said aqueous radiation curable composition.

### BACKGROUND

Plastics coatings represent a significant and high growth segment of the coating industry and target the challenging demand for advanced surface finish technologies covering aesthetics as well as additional protective and functional features. Coatings for the so-called 3C applications—which include computer, communication and consumer electronics—are particularly challenging to formulate as those make use of various low surface energy substrates comprising e.g. polycarbonate and additional synthetic polymers or fibres, and which are known to be difficult to bond substrates.

With the enforcement of evermore stringent VOC emission regulations across the globe, the demand for low VOC coating solutions is growing fast. In that context, waterborne radiation curable coating compositions have become increasingly popular in replacement of solvent borne resins. However, the aqueous radiation curable coating compositions known in the art are known to have limited use for challenging plastic applications due in particular to unsatisfactory adhesion performance.

A partial solution is described e.g. in US 2020/0181451A1 (Su et al.). Without contesting the technical advantages associated with the solutions known in the art, there is still a need for a low VOC radiation curable composition which overcomes at least partially the above-mentioned deficiencies.

### SUMMARY

According to one aspect, the present disclosure relates to an aqueous radiation curable composition comprising:
a) from 45 to 80 wt. % of at least one ethylenically unsaturated compound (A); and
b) from 20 to 55 wt. % of at least one ethylenically unsaturated polyurethane polymer (B) obtained from the reaction of:
   i. at least one polyisocyanate compound (i);
   ii. at least one polymeric polyol (ii);
   iii. at least one hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt;
   iv. at least one compound (iv) comprising at least one reactive group capable of reacting with isocyanate groups and further comprising at least one ethylenically unsaturated group; and
   v. optionally, at least one compound (v) comprising at least one reactive group capable of reacting with isocyanate groups; and
      wherein compounds (A), (i), (ii), (iii), (iv) and (v) are all different from each other, and wherein the wt. % are based on the total dry content weight of the radiation curable composition.

According to another aspect, the present disclosure is directed to a coating composition comprising an aqueous radiation curable composition as described above.

In still another aspect of the present disclosure, it is provided a process for the manufacturing of an aqueous radiation curable composition, comprising the steps of:
a) mixing and reacting compounds (i), (ii), (iii), and optionally compound (vi), as described above;
b) reacting the product of step a) with a compound (iv), as described above, thereby obtaining an ethylenically unsaturated polyurethane polymer (B);
c) adding at least one ethylenically unsaturated compound (A), as described above;
d) optionally, reacting the compound (iii) with a neutralizing agent in order to convert the hydrophilic groups provided by compound (iii) into anionic salts;
e) dispersing the ethylenically unsaturated polyurethane polymer (B) obtained in step b) or optional step d) in an aqueous medium; and
f) optionally, reacting the ethylenically unsaturated polyurethane polymer (B) obtained in step e) with a compound (v), as described above.

According to yet another aspect, the present disclosure relates to the use of an aqueous radiation curable composition or a coating composition as described above in computer, communication and consumer electronics applications, dual cure applications or thick pigmented systems.

### DETAILED DESCRIPTION

According to a first aspect, the present disclosure relates to an aqueous radiation curable composition comprising:
a) from 45 to 80 wt. % of at least one ethylenically unsaturated compound (A); and
b) from 20 to 55 wt. % of at least one ethylenically unsaturated polyurethane polymer (B) obtained from the reaction of:
   i. at least one polyisocyanate compound (i);
   ii. at least one polymeric polyol (ii);
   iii. at least one hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt;
   iv. at least one (polymerizable) compound (iv) comprising at least one reactive group capable of reacting with isocyanate groups and further comprising at least one ethylenically unsaturated group; and
   v. optionally, at least one (non-polymerizable) compound (v) comprising at least one (essentially one) reactive group capable of reacting with isocyanate groups; and
      wherein compounds (A), (i), (ii), (iii), (iv) and (v) are all different from each other, and wherein the wt. % are based on the total dry content weight of the radiation curable composition.

In the context of the present disclosure, it has been surprisingly found that an aqueous radiation curable composition as described above is provided with excellent colloidal stability, even under stringent ageing conditions, as well as advantageous formulation flexibility.

It has no less surprisingly been found that an aqueous radiation curable composition as described above is particularly suitable for forming coatings provided with excellent characteristics and performance attributes as regard to adhesion to challenging-to-bond plastic substrates (in particular polycarbonate, acrylonitrile butadiene styrene and any combinations thereof), hot water resistance, hydrolysis resistance, visual aesthetics even in complex formulations (such as e.g. metallic or matte formulations), abrasion resistance, stain resistance and low VOC features.

Without wishing to be bound by theory, it is believed that these excellent characteristics and attributes are due in particular to the use of a specific combination of: (a) at least one ethylenically unsaturated compound (A), and (b) at least one ethylenically unsaturated polyurethane polymer (B) obtained as described above; wherein the compound (A) and the polyurethane polymer (B) are comprised in the radiation curable composition in the specific ranges detailed above.

More specifically, it is believed that this specific combination of components in the particular weight ranges detailed above contributes to providing the aqueous radiation curable composition with advantageous characteristics, in particular relatively small particle size and excellent viscosity features, which in turn result into coatings provided with the excellent characteristics and performance attributes as detailed above.

Still without wishing to be bound by theory, it is further believed that the polyurethane polymer (B) obtained as described above-when used in combination with the at least one ethylenically unsaturated compound (A) in a range from 45 to 80 wt. %, based on the total dry content of the radiation curable composition-formally acts as an efficient internal stabilizer (or emulsifier) for the relatively high proportion of the ethylenically unsaturated compound (A), which in turns advantageously affects the stability of the resulting aqueous radiation curable composition.

This is a particularly surprising and counterintuitive finding considering that aqueous compositions comprising more than 30 wt. % of such ethylenically unsaturated compounds (A) are generally recognized to have insufficient stability and poor ageing resistance.

The specific ethylenically unsaturated polyurethane polymer (B) described above further allows achieving excellent design flexibility, which as such permits obtaining aqueous radiation curable compositions and coatings resulting therefrom with fine-tuned properties and excellent formulation flexibility. Moreover, the presence of an ethylenically unsaturation in the structure of the polyurethane polymer (B) is also believed to prevent (or at least substantially reduce) the presence of free stabilizers (or emulsifiers) after polymerization. The presence of these free or mobile stabilizers after curing is indeed known to detrimentally affect various properties of the resulting coating, in particular its (hot) water- and hydrolysis resistance, which in turn negatively affects its visual aesthetics, due to unwanted migration of these free stabilizers through the coating layer up to its external surface.

As such, the aqueous radiation curable composition of the present disclosure is outstandingly suitable for forming coatings for use in 3C applications.

The aqueous radiation curable composition of the present disclosure comprises, as a first component, at least one (polymerizable) ethylenically unsaturated compound (A) in an amount from 45 to 80 wt. %, based on the total dry content weight of the radiation curable composition.

In one advantageous aspect, the aqueous radiation curable composition comprises greater than 45 wt. %, greater than 50 wt. %, greater than 55 wt. %, greater than 60 wt. %, greater than 65 wt. %, greater than 70 wt. %, or even greater than 75 wt. %, of the at least one ethylenically unsaturated compound (A), based on the total dry content weight of the radiation curable composition.

In another advantageous aspect of the disclosure, the aqueous radiation curable composition comprises from 45 to 75 wt. %, from 45 to 70 wt. %, or even from 50 to 70 wt. %, of the at least one ethylenically unsaturated compound (A), based on the total dry content weight of the radiation curable composition.

Ethylenically unsaturated compounds (A) for use herein are not particularly limited. Suitable ethylenically unsaturated compounds (A) for use herein will be easily identified by those skilled in the art in the light of the present disclosure.

Compounds (A) for use herein comprise at least one, and typically at least two polymerizable ethylenically unsaturated groups per molecule, also referred to herein as “ethylenically unsaturated functional groups” or “ethylenically unsaturated groups”. By “polymerizable ethylenically unsaturated groups” throughout the present disclosure is meant to designate carbon-carbon double bonds which can undergo radical polymerization under the influence of irradiation. Examples of such groups are (meth)acryloyl, (meth)acrylamide, vinyl, vinylether, allyl, styrenyl, methylstyrenyl, maleyl or fumaryl functional groups. The ethylenically unsaturated groups for use herein are generally chosen from (meth)acryloyl groups and/or allyl groups, preferably they are (meth)acryloyl groups, more preferably acryloyl groups. In the present disclosure, the term “(meth)acryloyl” is to be understood as to encompass both acryloyl and methacryloyl groups or derivatives as well as mixtures thereof.

Compounds (A) for use in the present disclosure may be monomeric, oligomeric and/or polymeric ethylenically unsaturated compounds. Blends of monomeric, oligomeric and/or polymeric ethylenically unsaturated compounds (A) may also be used.

Typically, ethylenically unsaturated compounds (A) are monomeric or oligomeric in nature. Advantageously, the compounds (A) for use herein are oligomeric. Typical monomeric compounds (A) have a weight average molecular weight (M_{w}) in a range from 50 to 300 g/mol, from 100 to 250 g/mol, or even from 100 to 200 g/mol, when measured by conventional gel permeation chromatography (GPC) techniques. Typical oligomeric compounds (A) have a weight average molecular weight (M_{w}) in a range from 300 to 20,000 Dalton, from 500 to 15,000 Dalton, from 500 to 10,000 Dalton, or even from 800 to 5,000 Dalton, when measured by conventional gel permeation chromatography (GPC) techniques.

According to an advantageous aspect, the at least one ethylenically unsaturated compound (A) for use herein has a weight average molecular weight (M_{w}) no greater than 3000 g/mol, no greater than 2500 g/mol, no greater than 2000 g/mol, no greater than 1500 g/mol, no greater than 1200 g/mol, no greater than 1000 g/mol, no greater than 800 g/mol, no greater than 600 g/mol, no greater than 500 g/mol, no greater than 400 g/mol, no greater than 300 g/mol, or even no greater than 200 g/mol.

In another advantageous aspect, ethylenically unsaturated compounds (A) for use herein are water-insoluble compounds. By “a water-insoluble compound” is meant to designate in the present disclosure an ethylenically unsaturated compound that is not self-emulsifiable or self-dispersible, but forms emulsions or dispersions in water or in aqueous solutions in the presence of one or more reactive ionic external emulsifiers (B) as defined above. More in particular, and according to this advantageous aspect of the disclosure, compounds (A) are non-self-dispersible, non-self-emulsifiable, non-water-dilutable compounds. Typically, ethylenically unsaturated compounds (A) for use herein are not self-dispersible compounds. By a “self-dispersible compound” is meant to designate in the present disclosure a compound that, when mixed with water, forms a stable two-phase system of small particles dispersed in water without the aid of an additional emulsifier. By a “self-emulsifiable compound” is meant to designate in the present disclosure a compound that, when mixed with water, forms a stable two-phase system of small droplets dispersed in water without the aid of an additional emulsifier. By “stable” is meant to designate herein that there is substantially no coalescence (droplets) nor flocculation (particles) leading to phase separation, creaming or sedimentation of the heterogeneous system after 2 or more days, typically 4 or more days, preferably not even after 10 days at 60 °C. Typically, compounds (A) for use herein are not water-dilutable compounds. By a “water-dilutable compound” is meant to designate in the present disclosure a compound that permits to form a homogeneous, single phase mixture when the compound is mixed with water over a concentration range of 5 to 75 wt. % of water in the total mass of water and the compound, and this in the absence of emulsifiers.

In a typical aspect, the ethylenically unsaturated compounds (A) of the disclosure have a solubility at 25 °C of less than 50 g/l, less than 40 g/l, less than 30 g/l, less than 25 g/l, less than 20 g/l, less than 10 g/l, less than 5 g/l, or even less than 1 g/l.

Ethylenically unsaturated compounds (A) are typically characterized by an amount of copolymerizable ethylenically unsaturated groups of at least 1 meq/g, at least 2 meq/g, at least 3 meq/g, at least 4 meq/g, at least 5 meq/g, at least 6 meq/g, at least 7 meq/g, at least 8 meq/g, or even at least 9 meq/g. Typically this amount does not exceed 13 meg/g or even 12 meq/g. The amount of ethylenically unsaturated groups is typically measured by nuclear magnetic resonance spectroscopy (NMR) according to techniques well known in the art, and is expressed in meq per g of solid material.

In an exemplary aspect, ethylenically unsaturated compounds (A) for use herein comprise at least 2, at least 4, at least 6, at least 8, or even at least 10 or more ethylenically unsaturated functional groups per molecule.

Advantageously, the compounds (A) combine a functionality and degree of unsaturation as indicated above. In particular, preferred compounds (A) for use herein are characterized by a functionality of at least 2, at least 4, at least 6, at least 8, or even at least 10 or more ethylenically unsaturated groups per molecule; and by an amount of ethylenically unsaturated groups of at least 4 meq/g, at least 6 meq/g, at least 8 meq/g, or even at least 9 meq/g.

According to an exemplary aspect, ethylenically unsaturated compounds (A) for use in the present disclosure are (meth)acrylated compounds, in particular selected from the group consisting of urethane (meth)acrylates (A1), polyester (meth)acrylates (A2), polyepoxy (meth)acrylates (A3), polycarbonate (meth)acrylates (A4), polyether (meth)acrylates (A5), and polyacrylic (meth)acrylates (A6). Exemplary ethylenically unsaturated compounds (A) for use herein are amply detailed in U.S. Patent Application US2014/0377466-A1 (Tielemans et al.), the content of which is fully incorporated herein by reference.

According to one particular aspect of the disclosure, the ethylenically unsaturated compound (A) for use herein is selected from the group consisting of urethane (meth)acrylates (A1), polyester (meth)acrylates (A2), epoxy (meth)acrylates (A3), (meth)acrylic (meth)acrylates (A4), and any combinations or mixtures thereof.

In one preferred aspect, the ethylenically unsaturated compound (A) is selected from the group consisting of urethane (meth)acrylates (A1). Urethane (meth)acrylates have surprisingly been found to provide outstanding adhesion performance on challenging-to-bond plastic substrates (in particular polycarbonate, and acrylonitrile butadiene styrene, and any combinations thereof) which are particularly used in 3C applications.

In another preferred aspect, the ethylenically unsaturated compound (A) is selected from the group of (meth)acrylated compounds comprising no reactive group(s) capable of reacting with isocyanate groups, in particular from the group of (meth)acrylated compounds comprising at least two (meth)acryl groups.

In a particularly preferred aspect, the ethylenically unsaturated compound (A) is selected from the group consisting of hexanediol di(meth)acrylate, trimethylolpropane tri (meth)acrylate, glycerol tri(meth)acrylate, pentaerythritol tetra(meth)acrylate, di-trimethylolpropane tetra(meth)acrylate, di-pentaerythritol hexa(meth)acrylate and their (poly) ethoxylated and/or (poly) propoxylated equivalents, as well as any combinations or mixtures thereof.

In an alternative aspect, the ethylenically unsaturated compound (A) is selected from the group of (meth)acrylated compounds comprising reactive group(s) capable of reacting with isocyanate groups, in particular from the group of (meth)acrylated compounds comprising at least two (meth)acryl groups and one or more additional functional groups, in particular hydroxyl functional groups. These additional functional groups are typically meant to provide additional properties to the aqueous radiation curable composition.

In another beneficial aspect of the aqueous radiation curable composition of the present disclosure, the ethylenically unsaturated compound (A) for use herein is at least partially bio-based, and has in particular a biobased content of more than 10%, more than 20%, more than 40%, more than 60%, or even more than 80% by weight of total carbon content of the ethylenically unsaturated compound (A), when the biobased content is determined according to ASTM D6866 standard test method. Exemplary bio-based ethylenically unsaturated compounds (A) for use herein and methods for obtaining thereof, are also amply described in PCT Application WO 2022/128462 (Tielemans), the content of which is fully incorporated herein by reference.

The aqueous radiation curable composition of the present disclosure comprises, as a second component, at least one (polymerizable) ethylenically unsaturated polyurethane polymer (B) obtained from the reaction of at least one polyisocyanate compound (i). By polyisocyanate compound (i), it is meant to designate organic compounds comprising at least two isocyanate groups.

Polyisocyanate compounds (i) for use herein are not particularly limited. Suitable polyisocyanate compounds (i) for use herein will be easily identified by those skilled in the art in the light of the present disclosure. Polyisocyanate compounds (i) typically comprise no more than three isocyanate groups. Advantageously, the polyisocyanate compound (i) is a di-isocyanate.

In a typical aspect, the at least one polyisocyanate compound (i) is selected from aliphatic and cycloaliphatic polyisocyanates, in particular diisocyanates. Examples of aliphatic and cycloaliphatic polyisocyanates are 1,6-diisocyanatohexane (HDI), 1,1′-methylene bis[4-isocyanatocyclohexane] (H12MDI), 5-isocyanato-1-isocyanatomethyl-1,3,3-trimethylcyclohexane (isophorone diisocyanate, IPDI). Aliphatic polyisocyanates containing more than two isocyanate groups are for example the derivatives of above mentioned diisocyanates like 1,6-diisocyanatohexane biuret and isocyanurate. Examples of aromatic polyisocyanates are 1,4-diisocyanatobenzene (BDI), 2,4-diisocyanatotoluene (TDI), 1,1′-methylene bis[4-isocyanatobenzene] (MDI), xylilenediisocyanate (XDI), tetramethylxylilene diisocyanate (TMXDI), 1,5-naphtalene diisocyanate (NDI), tolidine diisocyanate (TODI) and p-phenylene diisocyanate (PPDI). Especially preferred are 1,1′-methylene bis[4-isocyanatocyclohexane] (H12MDI), isophorone diisocyanate (IPDI) and tetramethylxylilene diisocyanate (TMXDI).

The amount of polyisocyanate compound (i) used for the synthesis of the ethylenically unsaturated polyurethane polymer (B) is typically comprised in the range from 5 to 60 wt. %, from 10 to 50 wt. %, from 15 to 40 wt. %, or even from 20 to 30 wt. %, based on the total weight of the at least one ethylenically unsaturated polyurethane polymer (B).

The ethylenically unsaturated polyurethane polymer (B) is obtained from the reaction of further at least one polymeric polyol (ii). In the context of the present disclosure, the term “polymeric polyol” is meant to designate a polymer comprising at least two hydroxyl groups and a polymeric backbone, wherein the polymeric backbone typically has a weight average molecular weight (M_{w}) of at least 500 g/mol.

Polymeric polyols (ii) for use herein are not particularly limited. Suitable polymeric polyols (ii) will be easily identified by those skilled in the art in the light of the present disclosure. Advantageously, the polymeric polyols (ii) may be selected from high molecular weight polyols and low molecular weight polyols. Advantageously, the polymeric polyols (ii) are selected from high molecular weight polyols.

In a typical aspect, the at least one polymeric polyol (ii) has a weight average molecular weight (M_{w}) greater than 500 g/mol, greater than 600 g/mol, greater than 700 g/mol, greater than 800 g/mol, greater than 900 g/mol, or even greater than 1000 g/mol.

Typically still, the at least one polymeric polyol (ii) has a weight average molecular weight (M_{W}) no greater than 5000 g/mol, no greater than 4000 g/mol, no greater than 3000 g/mol, no greater than 2000 g/mol, no greater than 1500 g/mol, or even no greater than 1000 g/mol.

According to an exemplary aspect, the at least one polymeric polyol (ii) is selected from the group consisting of polycarbonate polyols, polyester polyols, polyether polyols, fatty dimer diols, polybutadiene polyols, polyacrylate polyols, silicone polyols, and any combinations or mixtures thereof.

Suitable polyacrylate polyols include those prepared by the radical polymerization of (meth)acrylic and/or (meth)acrylamide monomers initiated by a thermal radical initiator in the presence of an hydroxylated mercaptan and followed by the end-group transesterification with a short chain diol, such as 1,4-butanediol.

Suitable polyether polyols comprise polyethylene glycols, polypropylene glycols and polytetramethylene glycols, or bloc copolymers thereof. Suitable fatty dimer diols are obtained from the hydrogenation of dimer acids, preferably those comprising 36 carbon atoms.

In a beneficial aspect, the at least one polymeric polyol (ii) is selected from polycarbonate polyols, polyester polyols, and any combinations or mixtures thereof.

Suitable polyester polyols are especially the hydroxyl terminated reaction products of polyhydric, preferably dihydric, alcohols with polycarboxylic, preferably dicarboxylic, acids or their corresponding anhydrides, as well as those obtained from the ring opening polymerization of lactones. The polycarboxylic acids which may be used for the formation of these polyester polyols may be aliphatic, cycloaliphatic, aromatic and/or heterocyclic and they may be substituted, saturated or unsaturated. The polyhydric alcohols which may be used for the preparation of the polyester polyols include ethylene glycol, propylene glycol, 1,3-propanediol, 1,3-butanediol, 1,4-butanediol, 1,5-pentanediol, 1,6-hexanediol, neopentyl glycol, diethylene glycol, dipropylene glycol, triethylene glycol, tetraethylene glycol, dibutylene glycol, 2-methyl-1,3-pentanediol, 2,2,4-trimethyl-1,3-pentanediol, 1,4-cyclohexanedimethanol, ethylene oxide adducts or propylene oxide adducts of bisphenol A or hydrogenated bisphenol A. Polyols such as glycerin, trimethylolethane, trimethylolpropane, di-trimethylolethane, di-trimethylolpropane and pentaerythritol may also be used. Particularly advantageous polyester polyols are polyester polyols made from the polycondensation of neopentylglycol and adipic acid and/or isophthalic acid.

According to a particularly beneficial aspect of the present disclosure, the at least one polymeric polyol (ii) is selected from the group of polycarbonate polyols, in particular those resulting from the reaction of diols (such as ethylene glycol, 1,3-propanediol, 1,3-butanediol, 1,4-butanediol, 1,5-pentanediol, 1,6-hexanediol, diethylene glycol, triethylene glycol, dipropylene glycol, tripropylene glycol or tetraethylene glycol) with phosgene, with dialkylcarbonates (such as dimethycarbonate), with diarylcarbonates (such as diphenylcarbonate) or with cyclic carbonates (such as ethylene and/or propylene carbonate). Particularly advantageous polycarbonate polyols are aliphatic polycarbonate diols, in particular those commercially available from Covestro under the trade designation Desmophen® series.

The use of polycarbonate polyols has been found to provide outstanding adhesion performance on challenging-to-bond plastic substrates (in particular polycarbonate, and acrylonitrile butadiene styrene, and any combinations thereof), which are particularly used in 3C applications.

The amount of polymeric polyol (ii) used for the synthesis of the ethylenically unsaturated polyurethane polymer (B) is typically comprised in the range from 2 to 50 wt. %, from 3 to 30 wt. %, from 5 to 25 wt. %, or even from 7 to 25 wt. %, based on the total weight of the at least one ethylenically unsaturated polyurethane polymer (B).

The ethylenically unsaturated polyurethane polymer (B) is obtained from the reaction of further at least one (non-polymerizable) hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt.

Hydrophilic compounds (iii) for use herein are not particularly limited as long as they meet the above-described requirements. Suitable hydrophilic compounds (iii) will be easily identified by those skilled in the art in the light of the present disclosure. The hydrophilic compounds (iii) are typically polyols, in particular diols, comprising a functional group that can exhibit an ionic or non-ionic hydrophilic nature.

In one advantageous aspect, the at least one hydrophilic compound (iii) is a non-polymerizable compound (in particular, a compound not comprising any ethylenically unsaturated group), in particular selected from the group of polyols comprising one or more anionic salt groups, such as a carboxylate and sulfonate salt groups or acid groups which may be converted to an anionic salt group, such as carboxylic acid or sulfonic acid groups.

In a preferred aspect, the at least one hydrophilic compound (iii) is selected from hydroxycarboxylic acids represented by the general formula (HO)ₓR(COOH)_{y}, wherein R represents a straight or branched hydrocarbon residue having 1 to 12 carbon atoms, and x and y independently are integers from 1 to 3. Examples of these hydroxycarboxylic acids include citric acid, malic acid, lactic acid and tartaric acid. Particularly preferred hydroxycarboxylic acids are the alpha, alpha-dimethylolalkanoic acids, wherein x=2 and y=1 in the above general formula.

In a more preferred aspect, the at least one hydrophilic compound (iii) is selected from the group consisting of 2,2-dimethylolpropionic acid and 2,2-dimethylolbutanoic acid.

The amount of hydrophilic compound (iii) used for the synthesis of the ethylenically unsaturated polyurethane polymer (B) is typically comprised in the range from 1 to 25 wt. %, from 2 to 20 wt. %, from 3 to 15 wt. %, or even from 4 to 10 wt. %, based on the total weight of the at least one ethylenically unsaturated polyurethane polymer (B).

The ethylenically unsaturated polyurethane polymer (B) is obtained from the reaction of further at least one (polymerizable) compound (iv) comprising at least one (essentially one) reactive group capable of reacting with isocyanate groups and further comprising at least one ethylenically unsaturated group.

Compounds (iv) for use herein are not particularly limited as long as they meet the above-described requirements. Suitable compounds (iv) will be easily identified by those skilled in the art in the light of the present disclosure.

Advantageously, the at least one compound (iv) comprises essentially one reactive group capable of reacting with isocyanate groups and further comprises at least one, in particular at least two, ethylenically unsaturated group(s). Typically, the compound (iv) comprises at least one nucleophilic function capable of reacting with isocyanate groups.

In a more advantageous aspect, the reactive group of the at least one compound (iv) comprises an hydroxyl group, and the ethylenically unsaturated group(s) of the at least one compound (iv) are (meth)acrylic groups. Preferred are (meth)acryloyl mono-hydroxy compounds, more particularly poly(meth)acryloyl mono-hydroxy compounds.

Useful compounds (iv) include the esterification products of aliphatic and/or aromatic polyols with (meth)acrylic acid having a residual average hydroxyl functionality of 15 about 1. The partial esterification products of (meth)acrylic acid with tri-, tetra-, penta- or hexahydric polyols or mixtures thereof are preferred. In this context, it is also possible to use reaction products of such polyols with ethylene oxide and/or propylene oxide or mixtures thereof, or reaction products of such polyols with lactones, which add to these polyols in a ring-opening reaction. Examples of suitable lactones are gamma-butyrolactone and, in particular delta-valerolactone and epsilon-caprolactone. These modified or unmodified polyols are usually partly esterified with acrylic acid, methacrylic acid or mixtures thereof until the desired residual hydroxyl functionality is reached. Compounds (iv) obtained from the reaction of (meth)acrylic acid with aliphatic, cycloaliphatic or aromatic compounds bearing an epoxy functionality together with at least one (meth)acrylic functionality can be used as well. Other suitable compounds are the (meth)acrylic esters with linear and branched polyols in which at least one hydroxy functionality remains free, like hydroxyalkyl (meth)acrylates having 1 to 20 carbon atoms in the alkyl group. Preferred molecules in this category are hydroxyethyl (meth)acrylate, hydroxypropyl (meth)acrylate, hydroxybutyl (meth)acrylate.

In a preferred aspect, the at least one compound (iv) is selected from the esterification products of aliphatic and/or aromatic polyols with (meth)acrylic acid having a residual average hydroxyl functionality of about 1.

In a more preferred aspect, the at least one compound (iv) is selected from the group of poly(meth)acryloyl mono-hydroxy compounds, in particular from the group consisting of glycerol di(meth)acrylate, trimethylolpropane di(meth)acrylate, glycerol di(meth)acrylate, pentaerythritol tri(meth)acrylate, ditrimethylolpropane tri(meth)acrylate, dipentaerythritol penta(meth)acrylate and their (poly) ethoxylated and/or (poly) propoxylated equivalents, as well as any combinations or mixtures thereof. Even more preferably, the at least one compound (iv) is selected from the group consisting of pentaerythritol tri(meth)acrylate, dipentaerythritol penta(meth)acrylate, and any combinations or mixtures thereof.

The amount of compound (iv) used for the synthesis of the ethylenically unsaturated polyurethane polymer (B) is typically comprised in the range from 10 to 60 wt. %, from 20 to 60 wt. %, from 15 to 55 wt. %, from 20 to 55 wt. %, or even from 30 to 50 wt. %, based on the total weight of the at least one ethylenically unsaturated polyurethane polymer (B).

The ethylenically unsaturated polyurethane polymer (B) may be obtained from the reaction of further at least one optional (non-polymerizable) compound (v) comprising at least one reactive group capable of reacting with isocyanate groups. Compounds (v) for use herein are not particularly limited and will be easily identified by those skilled in the art in the light of the present disclosure.

In a typical aspect, the at least one compound (v) is a non-polymerizable compound (in particular, a compound not comprising any ethylenically unsaturated group) comprising at least one reactive group capable of reacting with isocyanate groups.

Typically, the compound (v) for use herein comprises at least one nucleophilic function capable of reacting with isocyanate groups. More typically, the reactive group capable of reacting with isocyanate groups is capable of reacting with free (or remaining) isocyanate end-groups of the ethylenically unsaturated polyurethane polymer (B) thereby resulting into a chain extension of the polyurethane polymer (B). Accordingly, the compound (v) for use herein may also be referred to as a chain-extender.

In the context of the present disclosure, it has been surprisingly found that the chain-extended ethylenically unsaturated polyurethane polymers (B) resulting from the use of the at least one compound (v) provide the aqueous radiation curable composition with enhanced colloidal stability, in particular with respect to those aqueous compositions having a relatively high content of the ethylenically unsaturated compounds (A), e.g. typically greater than 55 wt. %, greater than 60 wt. %, greater than 65 wt. %, or even greater than 70 wt. %, based on the total dry content weight of the radiation curable composition.

Without wishing to be bound by theory, it is believed that the enhanced colloidal stability is facilitated by the excellent compatibility ensured by the chain-extended ethylenically unsaturated polyurethane polymers (B) with the relatively high content of the ethylenically unsaturated compounds (A) present in the aqueous radiation curable composition, which in turn results into enhanced ageing stability of the resulting compositions.

Chain-extended ethylenically unsaturated polyurethane polymers (B) are also believed to advantageously affect the abrasion resistance of the coatings resulting from the corresponding aqueous radiation curable compositions.

In one advantageous aspect, the at least one compound (v) is selected from the group of active amino groups-containing compounds. More advantageously, the at least one compound (v) for use herein is selected from the group of (water-soluble) aliphatic, alicyclic, aromatic or heterocyclic primary or secondary polyamine or hydrazine having up to 60, in particular up to 12 carbon atoms.

In a more advantageous aspect, the at least one compound (v) is selected from the group consisting of meta-xylylenediamine, ethylene diamine, diethylene triamine, piperazine, 1,4-butanediamine, 1,6-hexanediamine, 1,8-octanediamine, 1,10-decanediamine, 1,12-dodecanediamine, 2-methylpentamethylenediamine, triethylene triamine, isophorone diamine (or 1-amino3-aminomethyl-3,5,5-trimethyl-cyclohexane), bis(4-aminocyclo hexyl) methane, bis(4-amino-3-methylcyclo hexyl) methane, polyethylene amines, polyoxyethylene amines and polyoxypropylene amines, hydrazine, as well as any combinations or mixtures thereof.

In still a more advantageous aspect, the at least one compound (v) is selected from the group consisting of meta-xylylenediamine, ethylene diamine, diethylene triamine, any combinations or mixtures thereof.

In a particularly advantageous aspect of the disclosure, the at least one compound (v) is selected to be meta-xylylenediamine. In the context of the present disclosure, it has been indeed surprisingly found that ethylenically unsaturated polyurethane polymers (B) chain-extended with meta-xylylenediamine advantageously affect the abrasion resistance as well as the non-yellowing characteristic of the coatings resulting from the corresponding aqueous radiation curable compositions.

When used for the synthesis of the ethylenically unsaturated polyurethane polymer (B), the amount of compound (v) is typically comprised in the range from 0 to 5 wt. %, from 0.1 to 5 wt. %, from 0.2 to 3 wt. %, from 0.5 to 3 wt. %, from 0.5 to 2 wt. %, from 1 to 2 wt. %, or even from 1 to 1.5 wt. %, based on the total weight of the at least one ethylenically unsaturated polyurethane polymer (B).

The ethylenically unsaturated polyurethane polymer (B) may be obtained from the reaction of further at least one optional (polymerizable) ethylenically unsaturated polyurethane polymer (B) is obtained from the reaction of further at least one compound (vi) comprising at least two reactive groups capable of reacting with isocyanate groups and further comprising at least two ethylenically unsaturated groups, wherein compounds (A), (i), (ii), (iii), (iv), (v) and (vi) are all different from each other. Compounds (vi) for use herein are not particularly limited and will be easily identified by those skilled in the art in the light of the present disclosure.

Typically, the optional compound (vi) for use herein comprises at least two nucleophilic functions capable of reacting with isocyanate groups and further comprises at least two ethylenically unsaturated groups. Advantageously, the at least one compound (vi) comprise hydroxyl groups, and the ethylenically unsaturated groups are (meth)acrylic groups.

More advantageously, the at least one compound (vi) is selected from the reaction products of aliphatic and aromatic diglycidyl compounds with (meth)acrylic acid. Aliphatic diglycidyl compounds derived from alpha, omega diols having 4 to 12 carbon atoms or from polyoxyalkylenediols, especially polyethylene glycol, polypropylene glycol or mixtures thereof that contain oxyalkylene groups, can be used. Preference is given, for example, to 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, hydrogenated bisphenol A diglycidyl ether and hydrogenated bisphenol F diglycidyl ether and their ethoxylated and/or propoxylated equivalents. It is also possible to employ diglycidyl esters, such as diglycidyl hexahydrophthalate. Aromatic diglycidyl compounds derived from bisphenol A and bisphenol F are advantageous.

In a particular advantageous aspect, the at least one compound (vi) is selected from diacrylate esters of bisphenol A and bisphenol F diglycidyl ethers, and their ethoxylated and/or propoxylated equivalents, as well as any combinations or mixtures thereof. It is also possible to employ diglycidyl esters, such as diglycidyl phthalate, N,N-diglycidyl aniline, N,N-diglycidyl-4-glycidyloxyaniline. Especially preferred is the diacrylate ester of bisphenol A diglycidyl ether.

When used for the synthesis of the ethylenically unsaturated polyurethane polymer (B), the amount of compound (vi) is typically comprised in the range from 0 to 30 wt. %, from 0.5 to 30 wt. %, from 1 to 20 wt. %, from 2 to 15 wt. %, or even from 3 to 10 wt. %, based on the total weight of the at least one ethylenically unsaturated polyurethane polymer (B).

According to an advantageous aspect, the aqueous radiation curable composition of the present disclosure, comprises from 25 to 55 wt. %, from 30 to 55 wt. %, or even from 30 to 50 wt. %, of the at least one ethylenically unsaturated polyurethane polymer (B), based on the total dry content weight of the radiation curable composition.

According to a particular aspect, the at least one ethylenically unsaturated polyurethane polymer (B) for use herein is obtained from the reaction of:
i. from 5 to 60 wt. %, from 10 to 50 wt. %, from 15 to 40 wt. %, or even from 20 to 30 wt. %, of the at least one polyisocyanate compound (i);
ii. from 2 to 50 wt. %, from 3 to 30 wt. %, from 5 to 25 wt. %, or even from 7 to 25 wt. %, of the at least one polymeric polyol (ii);
iii. from 1 to 25 wt. %, from 2 to 20 wt. %, from 3 to 15 wt. %, or even from 4 to 10 wt. %, of the at least one hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt;
iv. from 10 to 60 wt. %, from 20 to 60 wt. %, from 15 to 55 wt. %, from 20 to 55 wt. %, or even from 30 to 50 wt. %, of the at least one compound (iv) comprising at least one (essentially one) reactive group capable of reacting with isocyanate groups and further comprising at least one ethylenically unsaturated group;
v. optionally, from 0 to 5 wt. %, from 0.1 to 5 wt. %, from 0.2 to 3 wt. %, from 0.5 to 3 wt. %, from 0.5 to 2 wt. %, from 1 to 2 wt. %, or even from 1 to 1.5 wt. %, of at least one (non-polymerizable) compound (v) comprising at least one (essentially one) reactive group capable of reacting with isocyanate groups; and
vi. optionally, from 0 to 30 wt. %, from 0.5 to 30 wt. %, from 1 to 20 wt. %, from 2 to 15 wt. %, or even from 3 to 10 wt. %, of the at least one compound (vi) comprising at least two reactive groups capable to react with isocyanate groups and further comprising at least two ethylenically unsaturated groups;
wherein compounds (i), (ii), (iii), (iv), (v) and (vi) are all different from each other, and wherein the wt. % are based on the total weight of the at least one ethylenically unsaturated polyurethane polymer (B).

In a typical aspect, the ethylenically unsaturated polyurethane polymer (B) is a (meth)acrylated polyurethane polymer (B), wherein the ethylenically unsaturated functionalities are (meth)acrylic groups.

In another typical aspect, the ethylenically unsaturated polyurethane polymer (B) comprise less than 0.20 meq/g, less than 0.15 meq/g, less than 0.10 meq/g, less than 0.05 meq/g, or even less less than 0.01 meq/g, of allophanate groups.

According to a typical aspect, the ethylenically unsaturated polyurethane polymer (B) has a weight average molecular weight (M_{w}) greater than 3000 g/mol, greater than 5000 g/mol, greater than 8000 g/mol, greater than 10.000 g/mol, or even greater than 15.000 g/mol.

Typically still, the ethylenically unsaturated polyurethane polymer (B) has a weight average molecular weight (M_{w}) in a range from 2500 to 25.000 g/mol, from 3000 to 20.000 g/mol, from 5000 to 20.000 g/mol, from 8000 to 20.000 g/mol, from 8000 to 15.000 g/mol, or even from 10.000 to 15.000 g/mol.

According to the particular aspect whereby the ethylenically unsaturated polyurethane polymer (B) is chain-extended, in particular by reaction with at least one compound (iv) comprising at least one reactive group capable of reacting with isocyanate groups and further comprising at least one ethylenically unsaturated group, the resulting ethylenically unsaturated polyurethane polymer (B) has a weight average molecular weight (M_{w}) greater than 20.000 g/mol, greater than 30.000 g/mol, greater than 50.000 g/mol, greater than 80.000 g/mol, greater than 100.000 g/mol, greater than 120.000 g/mol, greater than 150.000 g/mol, greater than 180.000 g/mol, or even greater than 200.000 g/mol.

More particularly, the at least one ethylenically unsaturated (chain-extended) polyurethane polymer (B) has a weight average molecular weight (M_{w}) in a range from 25.000 to 300.000 g/mol, from 30.000 to 280.000 g/mol, from 50.000 to 250.000 g/mol, from 50.000 to 230.000 g/mol, from 80.000 to 230.000 g/mol, from 100.000 to 200.000 g/mol, or even from 150.000 to 200.000 g/mol.

In one advantageous aspect, the aqueous radiation curable composition of the present disclosure has a particle (droplet) size no greater than 400 nm, no greater than 350 nm, no greater than 300 nm, no greater than 250 nm, no greater than 200 nm, no greater than 150 nm, or even no greater than 100 nm, when determined by DLS measurements according to the test method described in the experimental section.

In another advantageous aspect, the aqueous radiation curable composition has a particle (droplet) size in a range from 80 to 350 nm, from 80 to 300 nm, from 80 to 250 nm, from 85 to 200 nm, from 85 to 150 nm, or even from 90 to 120 nm, when determined by DLS measurements according to the test method described in the experimental section.

In still another advantageous aspect, the aqueous radiation curable composition has a solid content in a range from 20 to 50 wt. %, from 30 to 50 wt. %, from 30 to 40 wt. %, or even from 35 to 40 wt. %, when determined by gravimetric method according to the test method described in the experimental section.

According to another beneficial aspect, the aqueous radiation curable composition as described herein has a viscosity no greater than 500 mPa·s, no greater than 400 mPa·s, no greater than 300 mPa·s, no greater than 200 mPa·s, no greater than 150 mPa·s, no greater than 100 mPa·s, or even no greater than 50 mPa·s, when determined according to the test method described in the experimental section.

According to more beneficial aspect, the aqueous radiation curable composition has a viscosity in a range from 10 to 500 mPa·s, from 20 to 400 mPa·s, from 50 to 300 mPa·s, from 50 to 250 mPa·s, from 50 to 200 mPa·s, from 50 to 150 mPa·s, or even from 50 to 100 mPa·s, when determined according to the test method described in the experimental section.

The aqueous radiation curable composition of the present disclosure is provided with advantageous characteristics, in particular relatively small particle size and relatively low viscosity, which not only beneficially affects its overall stability, but also contributes to providing the corresponding coatings and articles with the excellent characteristics and performance attributes as detailed hereinbefore.

Advantageously, the aqueous radiation curable composition as described herein may be at least partially bio-based, and has in particular a biocarbon content of more than 5%, more than 10%, more than 15%, or even more than 20% by weight of total carbon content of the composition, when the biobased content is determined according to ASTM D6866 standard test method.

As customary in the technical field, the aqueous radiation curable composition of the present disclosure may further comprise various additional ingredients depending on the targeted applications and properties for such composition. In a typical aspect, the aqueous radiation curable composition further comprises at least one additive selected from the group consisting of photo-initiators, inhibitors, anti-oxidants, biocides, UV stabilizers, UV absorbers, nanoparticles, dispersing agents, slip aids, fillers, plasticizing agents, flow additives, anti-foaming additives, rheology modifiers, anti-settling agents, wetting agents, defoaming agents, fire retardant agents, leveling agents, slip agents, water scavengers, matting agents, waxes, pigments, dyes, co-solvents, resinous materials dispersed or solubilized in the composition, and any combinations or mixtures thereof.

In one advantageous aspect, the aqueous radiation curable composition may further comprise one or more external thermal crosslinkers that allow dual cure (radiation and thermal). Examples of suitable polyisocyanates, polyaziridines, polycarbodiimides, polyepoxides, polyalkoxysilanes and metal salts like zirconium ammonium carbonate. Particularly suitable are polyisocyanates, in particular hydrophilic polyisocyanates commercially available from Covestro AG under trade designation BAYHYDUR.

The aqueous radiation curable composition of the present disclosure can be prepared in various ways according to techniques well known to those skilled in the art. In a typical procedure, the composition is prepared by mixing and reacting compounds (i), (ii), (iii), optionally compound (vi) and possibly other ingredients in an appropriate solvent at a temperature between 20 and 80 °C under stirring until a suitable isocyanate content is reached. The reaction product obtained is then further reacted with compound (iv), thereby obtaining an ethylenically unsaturated polyurethane polymer (B). The resulting polymer (B) may be chain-extended according to conventional procedures using in particular the optional compound (v).

The aqueous radiation curable composition as disclosed herein typically comprises from 25 to 95 wt. %, more typically from 35 to 60 wt. % of water, based on the total weight of the composition. The compositions according to the present disclosure typically comprises less than 25 wt. %, less than 20 wt. %, less than 15 wt. %, less than 10 wt. %, less than 5 wt. %, or even less than 1 wt. %, of organic solvents and volatile organic compounds (VOC), based on the total weight of the composition. Advantageously, the aqueous radiation curable compositions according to the present disclosure are free of organic solvents and volatile organic compounds.

According to another aspect, the present disclosure is directed to a coating composition comprising an aqueous radiation curable composition as described above. The aqueous radiation curable compositions disclosed herein are indeed particularly well suited for preparing coatings. All particular and preferred aspects relating to, in particular, the ethylenically unsaturated compounds (A) and the ethylenically unsaturated polyurethane polymer (B), and described hereinbefore in the context of the aqueous radiation curable composition, are fully applicable to the coating composition.

Advantageously, the coatings obtained from the aqueous radiation curable composition as described are provided with excellent characteristics and performance attributes as regard to adhesion to challenging-to-bond plastic substrates (in particular polycarbonate and acrylonitrile butadiene styrene), hot water resistance, hydrolysis resistance, visual aesthetics even in complex formulations (such as e.g. metallic or matte formulations), abrasion resistance, stain resistance and low VOC features.

In an advantageous aspect, the coating composition is a hardcoat composition. As such, the aqueous radiation curable composition of the present disclosure is outstandingly suitable for forming coatings for use in 3C applications, which are of particular interest in the context of the present disclosure. The product applications in this industry segment are indeed endless and they can be typically associated to consumer electronics (like mobile phone, computer, television, compact disk), to automotive plastics for interior application (like dashboard, trim) or exterior application (like headlight, mirror, bumper, wheel cover) and to industrial plastics (like film, label, box, toy, sport equipment, garden furniture).

The aqueous radiation curable compositions according to the present disclosure are also suitable for use in overprint varnishes, inks, adhesives and for coating three-dimensional articles.

According to yet another aspect, the present disclosure therefore relates to an ink (e.g. inkjet), overprint varnish, adhesive or three-dimensional article comprising an aqueous radiation curable composition or a coating composition as described above.

Yet another aspect of the disclosure relates to an article or substrate coated, printed or treated, at least partially, with an aqueous radiation curable composition, a coating composition, an ink, an overprint, a varnish or an adhesive as described above.

In still another aspect of the present disclosure, it is provided a process for the manufacturing of an aqueous radiation curable composition, comprising the steps of:
a) mixing and reacting compounds (i), (ii), (iii), and optionally compound (vi), as described above;
b) reacting the product of step a) with a compound (iv), as described above, thereby obtaining an ethylenically unsaturated polyurethane polymer (B);
c) adding at least one ethylenically unsaturated compound (A), as described above;
d) optionally, reacting the compound (iii) with a neutralizing agent in order to convert the hydrophilic groups provided by compound (iii) into anionic salts;
e) dispersing the ethylenically unsaturated polyurethane polymer (B) obtained in step b) or optional step d) in an aqueous medium; and
f) optionally, reacting the ethylenically unsaturated polyurethane polymer (B) obtained in step e) with a compound (v), as described above.

If compound (v) is used as chain extender, it is typically added after the optional neutralization step of the hydrophilic groups provided by compound (iii) and after dispersion of the ethylenically unsaturated polyurethane polymer (B). The chain extension of the ethylenically unsaturated polyurethane polymer (B) is performed according to conventional procedures well known to those skilled in the art.

According to yet another aspect, the present disclosure relates to a process for coating an object or a substrate, comprising the steps of:
a) providing an aqueous radiation curable composition or a coating composition as described above,
b) applying the composition onto at least part of the surface of the object or the substrate, and
c) curing the composition by subjecting the coated surface to actinic radiation and/or thermal energy.

Typically the curing step is preceded by a step of evaporating water. Typically at least 98% of the water, preferably at least 99%, preferably all of the water is evaporated. The active energy rays used for curing preferably are ultraviolet rays, electron beam, X-rays, radioactive rays or high frequency waves. Ultraviolet rays having a wavelength of from 180 to 400 nm are particularly preferred from economical viewpoint. Curing by irradiation may be followed, or alternatively replaced, by thermal curing in the presence of suitable external (thermal) crosslinkers.

In a particular aspect of the invention, the article or substrate comprises plastic, more in particular is made from plastic.

Aqueous radiation curable compositions or a coating compositions as described above are typically cured by ultraviolet irradiation, generally in the presence of photo-initiator. Alternatively, they can also be cured by electron-beam irradiation, allowing the use of compositions free of photo-initiator. The compositions according to the invention are providing extremely rapid curing characterized by a higher reactivity allowing higher line speed or less irradiative energy curing and increased productivity. Low energy ultraviolet light sources can also be used (LED lamps).

According to yet another aspect, the present disclosure relates to the use of an aqueous radiation curable composition or a coating composition as described above in in computer, communication and consumer electronics applications, dual cure applications or thick pigmented systems.

### Examples

The present disclosure is further illustrated by the following examples. These examples are merely for illustrative purposes only and are not meant to be limiting on the scope of the appended claims.

Throughout the present disclosure and example section, the following test and measurement methods are used to characterize the exemplary aqueous radiation curable compositions and the coatings obtained therefrom.

### Test Methods:

### A) Particle Size

Dynamic light scattering (DLS) measurements are used to characterize the hydrodynamic size of particles in the various aqueous compositions. Prior to the DLS measurements, the concentrated compositions are diluted using deionized distilled water, thereby obtaining a particle concentration of 0.05 w/w %. The diluted composition are then filtered. Subsequently, DLS measurements are performed at 23 °C using a Delsa Nano-c particle analyzer of Beckman-Coulter. Incident monochromatic light used in the DLS measurement has a wavelength of λ=658 nm. Scattered light is detected in near-backscattering geometry at an angle of 165°. The z-average particle size along with the polydispersity index is determined from a second-order cumulant analysis of the electric-field auto-correlation function. The single-particle diffusion coefficient is then estimated from the average decay constant. Therefrom, using Stokes' relationship, a median particle diameter d₅₀ can be derived.

### B) Solid Content

The solid content (SC) of the various aqueous compositions is determined by gravimetric method, which comprises a drying step for 2 hours at 120 °C.

### C) Viscosity

The viscosity of the various aqueous compositions is measured at 23 °C with a cone and plate type rheometer MCR092 (Paar-Physica) according to test method DIN EN ISO 3219. A fixed shear rate of 25 s-1 is used.

### D) Colloidal Stability

The colloidal stability of the various aqueous compositions is assessed at 23 °C by visually observing the decantation and/or phase separation (expressed in percent of the total height) on samples weighing 20 g and placed in an oven at 60 °C. The colloidal stability is herein reported as the number of days before a sedimentation exceeding 2% of the total height of the sample. In the context of the present disclosure, a good colloidal stability is achieved when no product deterioration is observed during at least 10 days at 60 °C.

### E) Molecular Weight and Polydispersity

The number-average molecular weight (Mn), the weight-average molecular weight (M_{W}) and polydispersity (D) are determined by conventional gel permeation chromatography (GPC) with Polystyrene standards EasyCal from Polymer Laboratories (Molecular Weight range: 200-400.000 g/mol). The samples are dissolved (1.0% wt./wt.) in tetrahydrofuran (THF) containing 0.5% toluene as Flow rate marker. The analysis are performed by liquid chromatography (Merck-Hitachi L7100) equipped with 3 PLGel Mixed-D LS polystyrene-divinylbenzene GPC columns (300×7.5 mm×5 μm). The components of the sample are separated by the GPC columns based on their molecular size in solution and detected by a Refractive Index detector. The data are gathered and processed by Polymer Laboratories Cirrus GPC software.

### F) Gloss Level

The evaluation of the gloss level is carried out on the coating formed on Leneta Plain White Chart. The gloss level values are given in gloss units [GU] for an angle of 60° and determined according to Test Method DIN EN ISO 2813.

### G) Adhesion

Adhesion performance (initial adhesion ADH) of the coatings to the surface of the corresponding substrate is assessed using a cross hatch test according to Test Method ASTM D3359 B. In each case, 5 parallel cuts of 1 cm long and spaced by 1 mm, are first made in the coating using a knife. Then, 5 parallel cuts of 1 cm long and spaced by 1 mm, are made in the transversal direction. Subsequently, an adhesive tape (Scotch®) is firmly pressed on the cross-cut coating and removed rapidly. The damage to the cross-cut surface area of the coating, which us due to adhesion loss, is expressed in a OB-5B scale, wherein a score of 5 corresponds to the best adhesion.

### H) Hot Water Resistance

This resistance test is performed only on those coatings presenting an excellent initial adhesion (ADH test=5B). The coating is immersed in hot water (temperature of 80 or 85 °C) for a period of 30 or 60 minutes. The cross hatch tape adhesion performance is re-evaluated on the dried coating according to the procedure described hereinbefore. The hot water resistance test is passed when at least a score of 4B is obtained.

### I) Hydrolysis Resistance

This resistance test is performed only on those coatings presenting an excellent initial adhesion (ADH test=5B) and according to industry test standard VW TL 226 (Volkswagen AG). The coated substrate is placed in a humidity chamber for a period of 96 hours at 60 °C and 95% relative humidity. The coating of the coated substrate is then evaluated on visual damage, gloss level and cross hatch adhesion after humidity testing. The hydrolysis resistance test is considered passed when the coating is not visually damaged and when the same level of gloss and adhesion is achieved before and after the test.

### J) Scratch Resistance

The scratch resistance is determined using Resistant Coating to Abrasion (RCA) abrader-Norman Tool Tester according to test method ASTM F-2357. The RCA test is performed using a Standard paper as the abrading material. Abrasion is made by pressing the standard paper on the coated polycarbonate substrate with the specific load (175 g). The paper is in contact with the rubber ring on the reverse side. The result is expressed as the number of cycles necessary before the coated substrate starts to visually show damage, haze or white areas. The higher the number of cycles, the better is the abrasion resistance.

### K) Stain Resistance

The stain resistance of the coating is assessed after application with a Meyer bar of a 50 micrometer wet layer on a non-porous substrate (white opacity chart, Leneta) sheet followed by drying during 6 min at 50 °C and UV curing at 80 W/cm Hg lamp with 5 m/min conveyer speed. The stain resistance is assessed 24 hours after curing of the coating, by applying on the coating glass microfiber filter pieces saturated with a test substance or using a black alcohol marler ref. Artline N70, and placed in contact of the coating during 16 hours. The test substances used are mustard, coffee, eosine, isobetadine, Methyl blue and ammonia (10% solution in water). The stains are then washed with a couple of rubs using a tissue saturated with water or isopropanol. The remaining stains are assessed visually using a 1-5 scale, 5=no residual stain. The average stain resistance score is indicated hereinafter. A high stain resistance (at least score 4) is expected to provide the best coating protection against any household product spillage.

### Raw Materials:

In the examples, the following raw materials and starting products are used:

H12MDI is 4,4′-methylenedicyclo hexyl diisocyanate, commercially available from Covestro.

IPDI is isophorone diisocyanate, commercially available from Evonik.

Desmophen® C 2102 is a polycarbonate diol having a molecular weight of 1000 g/mol, commercially available from Covestro. Referred to hereinafter referred as PC-1000.

DMPA is dimethylol propionic acid, commercially available from Geo Specialty Chemicals, Inc.

DPHA is a mixture of dipentaerythritol penta- and hexa acrylate and having an IOH in a range from 45 to 75, commercially available from Allnex Germany GmbH.

PETIA is pentaerythritol triacrylate, commercially available from Allnex Germany GmbH.

IRR 1094 is an hexafunctional aliphatic urethane acrylate oligomer, obtained from Allnex Germany GmbH.

Ebecryl®140 is ditrimethylolpropane tetraacrylate, commercially available from Allnex Germany GmbH. Referred to hereinafter referred as E-140.

TMPTA is trimethylolpropane triacrylate, commercially available from Allnex Germany GmbH.

HDDA is 1,6-Hexanediol diacrylate, commercially available from Allnex Germany GmbH.

EOEOEA is an ethoxy ethoxy ethyl acrylate, commercially available from Rahn USA Corp., under the trade designation Miramer M170.

MXDA is meta-xylylenediamine, commercially available from Huntsman.

Ebecryl®600 is an acrylic acid adduct of bisphenol A diglycidyl ether, commercially available from Allnex GmbH. Referred to hereinafter referred as E-600.

Additol®HDMAP (a.k.a photoinitiator 1173) is a photoinitiator, commercially available from Allnex GmbH, Germany. Referred to hereinafter referred as A-HDMAP.

BYK®349 is a polyether-modified siloxane, defoamer, commercially available from BYK.

Valikat Bi 2010 is bismuth carboxylate-based PU catalyst, commercially available from Umicore. Referred to hereinafter referred as VB-2010.

BHT is butylated hydroxytoluene, commercially available from Brenntag.

TEA is triethylamine, commercially available from BASF.

Tafigel® PUR40 is non-ionic polyurethane butyl triglycol/water, associative thickener, commercially available from Münzing. Referred to hereinafter referred as T-PUR40.

Tafigel® PUR65 is non-ionic polyurethane butyl triglycol/water, associative thickener, commercially available from Münzing. Referred to hereinafter referred as T-PUR80.

Additol®XL 250 is a an anionic wetting agent and dispersion agent phosphine commercially available from Allnex Germany GmbH. Referred to hereinafter referred as A-XL250.

Omnirad 500 is a photoinitiator commercially available from IGM Resins. Referred to hereinafter referred as OMN-500.

Additol®TPO is a phosphine oxide based photoinitiator, commercially available from Allnex GmbH, Germany. Referred to hereinafter referred as A-TPO.

NIPSIL E1011 is a matting agent, commercially available from Tosoh, Japan. Referred to hereinafter referred as N-E1011.

SBC AQJ6911 is an aluminum paste, commercially available from Changzhou Yale, China.

Butyl Cellosolve (BCS) is commercially available from Dow Chemicals.

Propylene glycol monomethyl ether (PGME) is commercially available from Dow Chemicals.

N,N-Dimethylethanolamine (DMEA) is commercially available from BASF.

### Examples

### Example 1: General Preparation of the Exemplary Aqueous Radiation Curable Compositions (Ex. 1 to Ex. 8) and Comparative Example (Ex. C1)

A double-wall glass reactor equipped with a mechanical stirrer, a thermocouple, a vapor condenser and a dropping funnel is charged with the polymeric polyol (ii), optionally the compound (vi), the hydrophilic compound (iii), the polyisocyanate compound (i), acetone and the catalyst (VB-2010 or DBTL). The reaction mixture is heated at 60 °C under stirring and kept under reflux until an appropriate isocyanate content has been reached. Then, compound (iv) is added to the reactor and the reaction mixture is kept under reflux until the isocyanate content reaches an appropriate value. Then, the ethylenically unsaturated compound (A) is added to the reaction mixture and stirred until an homogeneous mixture is obtained. The mixture is further cooled down to 45 °C and triethylamine is added under stirring. The resulting mixture is then added slowly to water at room temperature under high shear agitation until a stable aqueous composition is obtained. For the aqueous radiation curable compositions according to examples Ex. 1 to Ex. 7 and comparative example Ex. C1 including a chain extension step, compound (v) is added quickly after this stabilization step. The acetone is stripped off under vacuum at a temperature of 50 °C until its level by gas chromatography is below 0.15 wt %.

TABLE 1
Formulation of exemplary aqueous radiation curable compositions
(Ex. 1 to Ex. 8) and comparative example (Ex. C1).

| Components | | | | | | | | | |
|---|---|---|---|---|---|---|---|---|---|
| (in grams) | Ex. 1 | Ex. 2 | Ex. 3 | Ex. 4 | Ex. 5 | Ex. 6 | Ex. 7 | Ex. 8 | Ex. C1 |
| IPDI | 60.2 | 60.2 | 40.1 | 60.2 | 43.4 | 43.4 | 28.4 | — | — |
| H12MDI | — | — | — | — | — | — | — | 50.7 | 130.2 |
| E-600 | 13.3 | 13.3 | 8.8 | 13.3 | 8.4 | 8.4 | — | 9.5 | 24.3 |
| PC-1000 | 27.4 | 27.4 | 18.3 | 27.4 | 17.4 | 17.4 | 24.3 | 19.6 | 50.2 |
| DMPA | 16.7 | 16.7 | 11.2 | 16.7 | 12.7 | 12.7 | 8.1 | 11.9 | 30.6 |
| VB-2010 | 0.40 | 0.40 | 0.26 | 0.40 | 0.26 | 0.26 | 0.18 | 0.30 | 0.78 |
| DPHA | 126.8 | 126.8 | 84.5 | 126.8 | 80.3 | 80.3 | 57.6 | 90.5 | 232.3 |
| PETIA | — | — | — | — | — | — | — | 63.8 | 163.6 |
| BHT | 0.17 | 0.17 | 0.11 | 0.17 | 0.11 | 0.11 | 0.08 | 0.34 | 0.32 |
| IRR 1094 | 249.3 | 373.9 | 387.8 | 270.2 | 392.9 | — | 261.9 | — | — |
| E-140 | — | — | — | — | — | 115.5 | — | 230.6 | 31.6 |
| TMPTA | — | — | — | — | — | 277.4 | — | — | 75.7 |
| HDDA | — | — | — | 38.6 | — | — | — | — | — |
| EOEOEA | — | — | — | 11.7 | — | — | — | — | — |
| TEA | 12.8 | 12.8 | 8.5 | 12.8 | 9.9 | 9.9 | 5.8 | 8.4 | 23.11 |
| acetone | 55.1 | 55.1 | 36.7 | 55.1 | 37.4 | 37.4 | 25.1 | 53.5 | 137.1 |
| water | 926 | 1157 | 1029 | 1157 | 1046 | 1046 | 697 | 856 | 1372 |
| MXDA | 2.12 | 2.12 | 1.04 | 2.12 | 2.06 | 1.77 | 1.09 | — | — |

### Example 2: Characteristics and Stability Performance of Exemplary Aqueous Radiation Curable Compositions (Ex. 1 to Ex. 8)

The characteristics and stability performance of exemplary aqueous radiation curable compositions (Ex. 1 to Ex. 8) have been determined according to the test methods described hereinbefore. The exemplary compositions of Ex. 1 to Ex. 7 all comprise an ethylenically unsaturated polyurethane polymer (B) which was chain-extended, whereas exemplar composition of Ex. 8 comprises an ethylenically unsaturated polyurethane polymer (B) which was not chain-extended. The results are presented in Table 2 below.

TABLE 2
Characteristics and stability performance of exemplary aqueous
radiation curable compositions (Ex. 1 to Ex. 8).

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Compound | 50.4 | 60.4 | 70.4 | 56.7 | 70.7 | 70.7 | 68.8 | 48.3 |
| (A) | | | | | | | | |
| content ^{[1]} | | | | | | | | |
| Particle size | 98 | 124 | 213 | 108 | 197 | 186 | 223 | 215 |
| (nm) | | | | | | | | |
| Solid content | 35.3 | 35.7 | 35.3 | 35.1 | 35.4 | 35.7 | 35.4 | 35.2 |
| (wt. %) | | | | | | | | |
| Colloidal | >10D | >10D | >10D | >10D | >10D | >10D | >10D | >10D |
| stability at | | | | | | | | |
| 60 °C | | | | | | | | |

^{[1]} the values represented correspond to the wt. % based on the total dry content weight of the radiation curable composition.

As can be seen from the results shown in Table 2, the aqueous radiation curable compositions according to the present disclosure (Ex. 1 to Ex. 8) are provided with excellent colloidal stability, even under stringent ageing conditions, as well as advantageous characteristics, in particular relatively small particle size and relatively high solid content.

### Example 3: General Preparation of the Exemplary Clear Coating Compositions (Ex. 9 to Ex. 16) and Comparative Clear Coating Composition (Ex. C2)

Exemplary clear coating compositions according to Ex. 9 to Ex. 16 and a comparative clear coating according to Ex. C2 are further prepared based on the formulations described in Table 3 below. The comparative clear coating according to Ex. C2 is prepared based on the formulation of comparative example Ex. C1, which comprises 14.5 wt. % of compound (A), based on the total dry content weight of the composition of Ex. C1.

TABLE 3
Formulation of exemplary clear coating compositions (Ex. 9 to Ex. 16) and
comparative clear coating composition (Ex. C2).

| Components | | | | | | | | | |
|---|---|---|---|---|---|---|---|---|---|
| (in grams) | Ex. 9 | Ex. 10 | Ex. 11 | Ex. 12 | Ex. 13 | Ex. 14 | Ex. 15 | Ex. 16 | Ex. C2 |
| Composition # | Ex. 1 | Ex. 2 | Ex. 3 | Ex. 4 | Ex. 5 | Ex. 6 | Ex. 7 | Ex. 8 | Ex. C1 |
| BYK 349 | 0.5 | 0.5 | 0.5 | 0.5 | 0.5 | 0.5 | 0.5 | 0.5 | 0.5 |
| A-HDMAP | 2 | 2 | 2 | 2 | 2 | 2 | 2 | 2 | 2 |
| T-PUR40 | 1 | 1 | 1 | 1 | 1 | 1 | 1 | 1 | 1 |

The clear coating formulations are applied on a polycarbonate substrate using a bar coater, thereby obtaining 50 micrometers wet coating layers. The applied formulations are dried for 6 minutes at 50 °C, and the coatings are cured under UV lights at a cure speed of 5 m/min using 80 Watt/cm² Hg lamps. The cured coatings are then used for further testing.

### Example 4: General Preparation of Exemplary Metallic Coating Compositions (Ex. 17 to Ex. 19)

Exemplary metallic coating compositions according to Ex. 17 to Ex. 19 are further prepared based on the formulations described in Table 4 below.

TABLE 4
Formulation of the exemplary metallic coating
compositions (Ex. 17 to Ex. 19).

| Components (in grams) | Ex. 17 | Ex. 18 | Ex. 19 |
|---|---|---|---|
| Composition # | Ex. 1 | Ex. 2 | Ex. 4 |
| N-E1011 | 0.5 | 0.5 | 0.5 |
| SBC AQJ911 | 6 | 6 | 6 |
| BCS | 6 | 6 | 6 |
| PGME | 3 | 3 | 3 |
| A-XL250 | 0.25 | 0.25 | 0.25 |
| T-PUR80 | 2 | 2 | 2 |
| TPO | 1.8 | 1.8 | 1.8 |
| OMN-500 | 1.5 | 1.5 | 1.5 |
| DMEA 10% | 5 | 5 | 5 |
| water | 10 | 10 | 10 |

The metallic coating formulations are applied on a plastic substrate (PC or ABS) using a spray coater. The applied formulations are dried for 10 minutes at 60 °C, thereby obtaining a dry film thickness (DFT) of about 10 micrometers. The coatings are subsequently cured under UV lights at a cure speed of 5 m/min using 80 Watt/cm2 Hg lamps. The cured coatings are then used for further testing.

### Example 5: Stain Resistance Performance of the Exemplary Clear Coatings (Ex. 9 to Ex. 13)

The stain resistance performance of the exemplary clear coatings (Ex. 9 to Ex. 13) have been determined according to the test methods described hereinbefore. The results are presented in Table 5 below.

TABLE 5
Stain resistance performance of the exemplary
clear coatings (Ex. 9 to Ex. 13).

| | Ex. 9 | Ex. 10 | Ex. 11 | Ex. 12 | Ex. 13 |
|---|---|---|---|---|---|
| Stain resistance (average) | 4.2 | 4.3 | 4.2 | 4.3 | 4.4 |

As can be seen from the results shown in Table 5, clear coatings according to the present disclosure (Ex. 19 to Ex. 13) are provided with excellent stain resistance against various types of staining substances.

### Example 6: Adhesion and Hot Water Resistance Performance of the Exemplary Clear Coatings (Ex. 11 to Ex. 16) and the Comparative Clear Coating (Ex. C2)

Adhesion to polycarbonate substrate, as well as hot water resistance performance of the exemplary clear coatings (Ex. 11 to Ex. 16) and the comparative clear coating (Ex. C2), have been determined according to the test methods described hereinbefore. The results are presented in Table 6 below.

TABLE 6
Adhesion and hot water resistance performance of the exemplary clear
coatings (Ex. 11 to Ex. 16) and the comparative clear coating (Ex. C2).

| | Ex. 11 | Ex. 12 | Ex. 13 | Ex. 14 | Ex. 15 | Ex. 16 | Ex. C2 |
|---|---|---|---|---|---|---|---|
| Adhesion/PC | 5B | 5B | 5B | 5B | 5B | 5B | 5B |
| Hot water resistance | 5B | 5B | 5B | 5B | 5B | 5B | 0B |
| (after 60 min at 80 °C) | | | | | | | |

As can be seen from the results shown in Table 6, clear coatings according to the present disclosure (Ex. 11 to Ex. 16) are provided with excellent performance attributes as regard to adhesion to polycarbonate substrate and hot water resistance, even under stringent conditions. In contrast, it can be seen that the performance and characteristics obtained using a comparative clear coating not according to the present disclosure (Ex. C2) are less advantageous. In particular, the comparative clear coating is typically deficient in terms of hot water resistance.

### Example 7: Hydrolysis Resistance Performance of the Exemplary Clear Coatings (Ex. 14 and Ex. 16) and the Comparative Clear Coating (Ex. C2)

Adhesion to polycarbonate substrate, as well as hot water resistance performance of the exemplary clear coatings (Ex. 14 and Ex. 16) and the comparative clear coating (Ex. C2), have been determined according to the test methods described hereinbefore. The results are presented in Table 7 below.

TABLE 7
Hydrolysis resistance performance of the exemplary clear coatings
(Ex. 14 and Ex. 16) and the comparative clear coating (Ex. C2).

| | Ex. 14 | Ex. 16 | Ex. C2 |
|---|---|---|---|
| Hydrolysis resistance | 5B | 5B | 0B |
| (after 96 hours at 60 °C and | | | |
| 95% relative humidity) | | | |

As can be seen from the results shown in Table 7, clear coatings according to the present disclosure (Ex. 11 and Ex. 16) are provided with excellent hydrolysis resistance performance, even under stringent conditions. In contrast, it can be seen that the hydrolysis resistance performance obtained using a comparative clear coating not according to the present disclosure (Ex. C2) is not satisfactory.

### Example 8: Performance Attributes of the Exemplary Metallic Coatings (Ex. 17 to Ex. 19)

Various performance attributes of the exemplary metallic coatings (Ex. 17 to Ex. 19), in particular adhesion to polycarbonate substrates, scratch resistance and gloss level, have been determined according to the test methods described hereinbefore. The results are presented in Table 8 below.

TABLE 8
Performance attributes of the exemplary
metallic coatings (Ex. 17 to Ex. 19).

| | Ex. 17 | Ex. 18 | Ex. 19 |
|---|---|---|---|
| Adhesion/PC | 5B | 5B | 5B |
| Scratch resistance | 70 | 40 | 95 |
| (in RCA cycles) | | | |
| Gloss level (in gloss units | 15.1 | 15.1 | 15.4 |
| for an angle of 60°) | | | |

As can be seen from the results shown in Table 8, metallic coatings according to the present disclosure (Ex. 17 to Ex. 19) are provided with excellent performance attributes as regard to adhesion to polycarbonate substrates, scratch resistance and gloss level.

1. An aqueous radiation curable composition comprising:
a) from 45 to 80 wt. % of at least one ethylenically unsaturated compound (A); and
b) from 20 to 55 wt. % of at least one ethylenically unsaturated polyurethane polymer (B) obtained from the reaction of:
i. at least one polyisocyanate compound (i);
ii. at least one polymeric polyol (ii);
iii. at least one hydrophilic compound (iii) comprising at least one reactive group capable of reacting with isocyanate groups and at least one group which is capable of rendering the polyurethane polymer (B) dispersible in aqueous medium either directly or after the reaction with a neutralizing agent to provide a salt;
iv. at least one compound (iv) comprising at least one reactive group capable of reacting with isocyanate groups and further comprising at least one ethylenically unsaturated group; and
v. optionally, at least one compound (v) comprising at least one reactive group capable of reacting with isocyanate groups; and
wherein compounds (A), (i), (ii), (iii), (iv) and (v) are all different from each other, and wherein the wt. % are based on the total dry content weight of the radiation curable composition.

2. The composition according to claim 1, which comprises greater than 45 wt. % of the at least one ethylenically unsaturated compound (A), wherein the wt. % is based on the total dry content weight of the radiation curable composition.

3. The composition according to claim 1, wherein the at least one ethylenically unsaturated compound (A) is selected from the group consisting of a monomer, an oligomer, a polymer and a combination or mixture thereof.

4. The composition according to claim 1, wherein the at least one ethylenically unsaturated compound (A) is selected from the group consisting of a urethane (meth)acrylate (A1), a polyester (meth)acrylate (A2), an epoxy (meth)acrylate (A3), a (meth)acrylic(meth)acrylate (A4), and a combination or mixture thereof.

5. The composition according to claim 1, wherein the at least one polymeric polyol (ii) has a weight average molecular weight (M_{w}) greater than 200 g/mol.

6. The composition according to claim 1, wherein the at least one polymeric polyol (ii) is selected from the group consisting of a polycarbonate polyol, a polyester polyol, a polyether polyol, a fatty dimer diol, a polybutadiene polyol, a polyacrylate polyol, a silicone polyol, and a combination or mixture thereof.

7. The composition according to claim 1, wherein the at least one hydrophilic compound (iii) is a non-polymerizable compound.

8. The composition according to claim 1, wherein the at least one compound (iv) comprises one reactive group capable of reacting with isocyanate groups and further comprises at least two ethylenically unsaturated group(s).

9. The composition according to claim 1, wherein the at least one compound (v) is selected from the group of aliphatic, alicyclic, aromatic or heterocyclic primary or secondary polyamine or hydrazine having up to 60 carbon atoms.

10. The composition according to claim 1, wherein the at least one ethylenically unsaturated polyurethane polymer (B) is obtained from the reaction of at least one compound (vi) comprising at least two reactive groups capable of reacting with isocyanate groups and at least two ethylenically unsaturated groups, wherein compounds (A), (i), (ii), (iii), (iv), (v) and (vi) are all different from each other.

11. The composition according to claim 1, which comprises from 25 to 55 wt. % of the at least one ethylenically unsaturated polyurethane polymer (B), based on the total dry content weight of the radiation curable composition.

12. The composition according to claim 1, which has a particle size no greater than 400 nm wherein the particle size is determined by dynamic light scattering (DLS) measurements.

13. A coating composition comprising an aqueous radiation curable composition according to claim 1, and at least one additive selected from the group consisting of a photo-initiator, inhibitor, anti-oxidant, biocide, UV stabilizer, UV absorber, nanoparticle, dispersing agent, slip aid, filler, plasticizing agent, flow additive, antifoaming additive, rheology modifier, anti-settling agent, wetting agent, defoaming agent, fire retardant agent, leveling agent, slip agent, water scavenger, matting agent, wax, pigment, dye, co-solvent, resinous material dispersed or solubilized in the composition, and combinations or mixtures thereof.

14. A process for manufacturing of an aqueous radiation curable composition, comprising the steps of:
a) mixing and reacting compounds (i), (ii), (iii), and optionally compound (vi), as described in claim 1;
b) reacting the product of step a) with a compound (iv), as described in claim 1, thereby obtaining an (end-capped) ethylenically unsaturated polyurethane polymer (B);
c) adding at least one ethylenically unsaturated compound (A), as described in claim 1;
d) optionally, reacting the compound (iii) with a neutralizing agent in order to convert the hydrophilic groups provided by compound (iii) into anionic salts;
e) dispersing the ethylenically unsaturated polyurethane polymer (B) obtained in step b) or optional step d) in an aqueous medium; and
f) optionally, reacting the ethylenically unsaturated polyurethane polymer (B) obtained in step e) with a compound (v), as described in claim 1.

15. (canceled)
